(19) United States
(12) Patent Application Publication
(10) Pub. No.: US 2003/0031286 A1
(43) Pub. Date: Feb. 13, 2003

(54) Process for making protons, neutrons and atoms

(76) Inventor: John R. Ross, Del Mar, CA (US)

Correspondence Address: Ross Patent Law Office, P.O. Box 2138, Del Mar, CA, 92014, US

(21) Appl. No.: 09/908,297

(22) Filed: Jul. 17, 2001

(51) Int. Cl. G21G 1/00

(52) U.S. Cl. 376/156

(57) ABSTRACT

A process for analyzing subatomic particles. A model of a proton is created that is comprised of only electrons, the electrons including a plurality of positrons and a plurality of negatrons, with at least one of said electrons orbiting at least one other of said electrons at a velocity great enough to increase the mass of electrons to equal a proton mass of about 1.67×10⁻²⁷ kg. A digital computer is programmed to perform analyses using the proton model. Preferably, the proton model includes: (A) a first positron, (B) two negatrons orbiting said first positron each negatron orbiting at a velocity, defining a negatron velocity, very near the speed of light, said first positron and said two orbiting negatrons defining a center three-some, and (C) two positrons orbiting said center three-some. Preferred embodiments of the present invention include processes for analyzing forces acting in atomic nuclei. Embodiments of the present invention can be utilized to analyze hydrogen thermonuclear reactions. The present invention also provides a process for creating protons is in a particle accelerator.

This invention relates to processes for conducting nuclear research and especially to processes for conducting nuclear research regarding subatomic particles.

### BACKGROUND OF THE INVENTION

### What We are Made of

Since civilizations first developed the smartest men in the world have sought to explain what we and the rest of the universe are made of. Scientist have discovered that the observable universe seems to be comprised of atoms each of which comprise a nucleus having a positive charge surrounded by one or more electrons each having a negative charge. There is general agreement among leading nuclear scientists that the nuclei of all atoms except H¹ consists of protons and neutrons, H¹ having only a single proton and no neutron in the nucleus.

### Electrons—Positrons and Negatrons

The word “electron” can be used to refer to only negative electrons or it can be used more generally to refer to either negative or positive electrons. Most of us are very familiar with negative electrons. A “positron” is a positive electron. Another name for the negative electrons is “negatron”. A positron has a mass equal to the mass of a negative electron and a charge opposite that of the negative electron. When the term “electron” is used later in this specification, its meaning will be clear so long as the reader understands that the word has these two possible meanings.

Experiments indicate that the size (distance across) of a typical atom is about 10⁻¹⁰ meter. The size of the nucleus of a typical atom (such as sodium with 26 proton and 26 neutrons) is about 10⁻¹⁴ m or about 1/10,000 the size of the atom. The size of a proton is about 10⁻¹⁵ m. The size of an electron is not known for certain but scattering experiments indicate that electrons are smaller that 10⁻¹⁸ m, and they may be point-like. A diameter of 10⁻¹⁸ would make the electron about 1,000 times smaller than a proton. (For H¹ a single proton comprises the nucleus. For all atoms other than H¹ the nucleus is believed to include a roughly equal number of protons and neutrons with the neutron-proton ration generally getting larger for heavier atoms.)

### Charges

A negative electron (negatron) has a negative charge of −1.6×10⁻¹⁹ Coulomb. The prior art teaches that a proton has an equal and opposite positive charge of +1.6×10⁻¹⁹ C. Neutral atoms have an equal number of positive protons in the nucleus and surrounding negative electrons (negatrons) so that at distances greater than atomic dimensions, the neutral atom has no charge that is apparent to us.

### Creation of Mass

Pair production is an event in which a gamma ray photon, with no apparent mass, but with energy in excess of 1.02 MeV interacts with matter to create a negatron-positron pair. The “rest mass” of a negatron is 9.1100×10⁻³¹ kilograms which in energy units is equal to 0.511 MeV. The rest mass of the positron is exactly the same as that of the negatron. It is also known that the combination of a positron and a negatron results in the annihilation of both of them with the release of two photons each having energy of 0.511 MeV.

### Masses

As stated above, the rest mass of an electron (positive or negative) is 9.1100×10⁻³¹ kg (or 0.000911×10⁻²⁷ kg). The reported mass of a proton is about 1.6726×10⁻²⁷ kg and the rest mass of a neutron is about 1.6750×10⁻²⁷ kg. The combined mass of a proton and an electron is about 15×10⁻³¹ kg less than the mass of a neutron. According to Einstein's theory of relativity the mass of a particle increases as its velocity increases according to the following relationship:

$$m = \frac{{m}_{0}}{\sqrt{1 - {( v / c )}^{2}}}$$

where v is the velocity and c is the speed of light.

### Atomic and Nuclear Forces

### Forces on Orbiting Electrons

The electrical force between charged particles is governed by Coulomb's Law and is defined by the following equation:

$$F = \frac{{q}_{1} {q}_{2}}{4 {πϵ}_{0} {r}^{2}}$$

The ratio 1/4πe₀=9.0×10⁹ Nm²/C² and the radius r of the hydrogen atom is about 5.3×10⁻¹¹ m. Therefore, (making the assumption that the electron is orbiting at the outer region of the atom and the proton is at the center) the attractive force between the proton and the electron in the hydrogen atom is about:

$$F = \frac{( 9.0 \times {10}^{9} {Nm}^{2} / {C}^{2} ) {( 1.6 \times {10}^{- 19} C )}^{2}}{{( 5.3 \times {10}^{- 11} )}^{2}}$$

$$F = 8.2 \times {10}^{- 8} N$$

The electron is not pulled into the nucleus. Why this is so is not completely understood. One explanation is that the electron orbits at an orbital velocity great enough so that the centripetal force on it exactly matches the attractive electrical force. Centripetal force is:

$$F = \frac{{mv}^{2}}{r}$$

If this is correct, the velocity of the electron would be about:

$$v = \sqrt{F \frac{r}{m}} = \sqrt{\frac{( 8.2 \times {10}^{- 8} N ) ( 5.3 \times {10}^{- 11 } m )}{9.1 \times {10}^{- 31} kg}}$$

$$v = 2.18 \times {10}^{6} m \text{/} s .$$

This is a very large velocity, almost 1 percent the speed of light. The modern thinking is that the electrons surrounding the nucleus should not be thought of as being in a defined orbit, but instead some sort of electron cloud is suggested.

### Forces in the Nucleus

In all atoms except H¹, there are multiple protons closely packed in the nucleus along with a roughly equal number of neutrons. Thus, these protons are believed to exert tremendous repulsive forces against each other as suggested by the following example of two protons separated by 4.0×10⁻¹⁵ m, which is a typical nucleus dimension:

$$F = \frac{{q}_{1} {q}_{2}}{4 {πϵ}_{0} {r}^{2}} = \frac{( 9.0 \times {10}^{9} {Nm}^{2} / {C}^{2} ) {( 1.6 \times {10}^{- 19} C )}^{2}}{{( 4.0 \times {10}^{- 15} m )}^{2}}$$

$$F = 14 N$$

A force of 14 N is equivalent to about 3.2 pounds, this force acting on the two protons each of which has a mass of only 9.1×10⁻³¹ kg should cause the protons to fly apart with enormous velocities. This typically does not happen. There is a current belief among the most knowledgeable nuclear scientists that there must be some other force acting in the nucleus to hold it together. Scientists call this force the “strong force”. The Applicant is not aware of any specific proof of this “strong force”. Nevertheless most leading nuclear scientists apparently have accepted this concept of this strong force.

### Quarks

Modern nuclear scientists have tried to explain the structure of protons and neutrons. There is a general belief that protons and neutrons are comprised of particles they call “quarks”. They think there are various types of quarks including “u-type” quarks and “d-type” quarks. The idea is that protons and neutrons are made up of three quarks each. The proton is supposed to be comprised of two u-type quarks and one d-type quark. The neutron is supposed to be comprised of two d-type quarks and one u-type quark. Since the u-type quarks are suppose to have a charge of 2e/3 and the d-type quarks a charge of −e/3 (where e is the magnitude of the electron charge), the net charge of the proton is +e and the net charge of the neutron is zero.

Apparently, no definite proof of this strong force has been presented. Furthermore, no isolated quark has ever been observed. (See, for example, Chapter 15, pages 608-651, Modern Physics, Second Edition, Serway et al, Saunders College Publishing for a general discussion of these issues, especially page 633.) Nevertheless, most leading nuclear physicists apparently have accepted these concepts of strong forces and quarks as truth.

### The Need

Prior existing descriptions of the basic building blocks of the universe are not satisfactory. What is needed is a simpler unifying description of the particles making up the atomic nucleus and a description of processes for forming protons, neutrons, nuclei, atoms and universes and techniques and processes for confirming or disproving this simpler unifying description.

### SUMMARY OF THE INVENTION

The present invention provides a process for analyzing subatomic particles. A model of a proton is created that is comprised of only electrons, the electrons including a plurality of positrons and a plurality of negatrons, with at least one of said electrons orbiting at least one other of said electrons at a velocity great enough to increase the mass of electrons to equal a proton mass of about 1.67×10⁻²⁷ kg. A digital computer is programmed to perform analyses using the proton model. Preferably, the proton model includes: (A) a first positron, (B) two negatrons orbiting said first positron each negatron orbiting at a velocity, defining a negatron velocity, very near the speed of light, said first positron and said two orbiting negatrons defining a center three-some, and (C) two positrons orbiting said center three-some. Preferred embodiments of the present invention include processes for analyzing forces acting in atomic nuclei. Embodiments of the present invention can be utilized to analyze hydrogen thermonuclear reactions. The present invention also provides a process for creating protons is in a particle accelerator.

### BRIEF DESCRIPTION OF THE DRAWINGS

FIG. 1 is a representation of a proton.

FIG. 2 is a representation of a neutron.

FIG. 3A is a representation of an alpha particle minus two negatrons.

FIG. 3B is a representation of an alpha particle.

FIG. 4 is a representation of a portion of an alpha particle.

FIG. 5 is a graph showing forces between particles in a nucleus according to a Ross model.

### DETAILED DESCRIPTION OF PREFERRED EMBODIMENTS

The present invention can be described by reference to the drawings.

### The Universe may be Comprised of Only Electrons—Positrons and Negatrons

The present invention is based on Applicant's discovery the known universe can logically be described as being comprised of nothing more than electrons (i.e., positrons and negatrons), the negatron having a negative charge −e and the positron having a positive charge of +e, and that the only forces acting in the universe is the electrical forces described by Coulomb's Law, i.e.:

$$F \approx \frac{{q}_{1} {q}_{2}}{{r}^{2}}$$

Thus, everything in the universe is comprised of combinations of these two simple point-like charges most of which were created in equal number at the time of the “Big Bang” from the electromagnetic energy released in that event. Protons and neutrons are made of positrons and negatrons, not quarks. Atomic nuclei are made up of positrons and negatrons. The nucleus of each neutral atom contains a number of positrons in excess of negatrons, the difference being equal to the number of orbiting negatrons. There is no strong force. A proton is a combination of three positrons and two negatrons in which two negatrons are orbiting a positron at velocities very close to the speed of light and two additional positrons orbit the central three-some further out to define the size of the proton. The Coulomb force holds the positrons and negatrons of the nucleus together and centripetal force and the Coulomb force combine forces to keep the particles appropriately separated. There probably is no separate gravitational force, but that force that we have believed was gravity is merely another manifestation of the Coulomb force.

### The Proton

### Structure

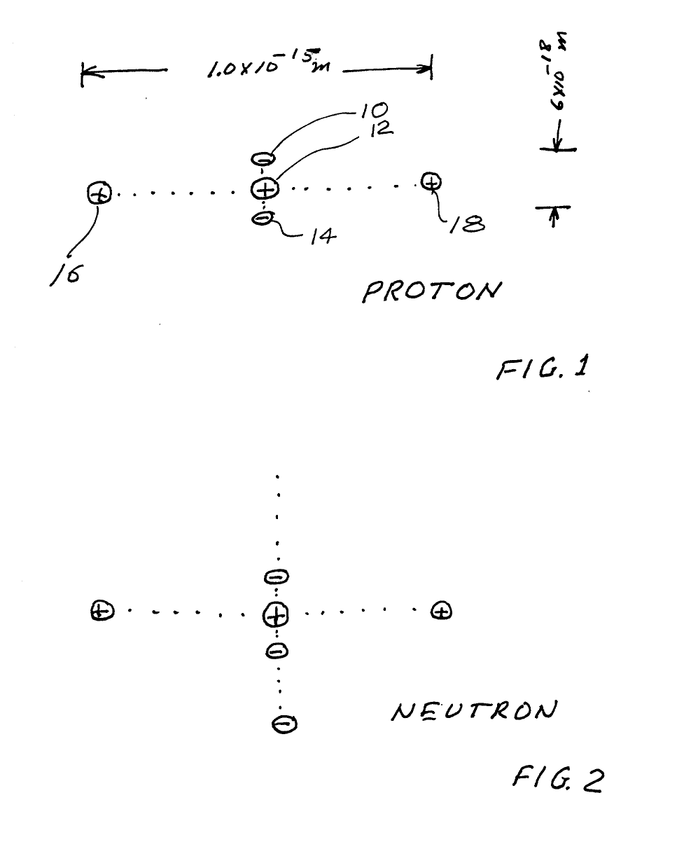

A proton model is proposed that I call the Ross Proton Model. In accordance with this model a proton is comprised of a central three-some consisting of a single positron orbited by two negatrons at extremely large velocities with two more positrons orbiting the central three-some, all as shown in FIG. 1. A neutron has the same general structure as a proton, but an additional electron (as shown in FIG. 2) orbits the two negatrons and three positrons. In the nucleus the neutron's extra electrons are probably shared so that protons and neutrons are probably not distinguishable in the nucleus. As stated in the Background section, it is known that the electron rest mass is 9.1×10⁻³¹ kg and the reported mass of a proton is 1.6731×10⁻²⁷ kg and the reported mass of a neutron is about 1.6754×10⁻²⁷ kg.

### Two Very Fast Moving Negatrons

Most of the apparent mass of the proton and the neutron is accounted for by the two negatrons which are orbiting the center position at a radius of about 3×10⁻¹⁸ m and at a velocity almost equal to the speed of light, i.e., an orbit velocity of about 0.9999994 C which gives each of them an apparent mass of about one half the reported mass of a proton and about one half the mass of a neutron.

The above velocity is estimated from the following equation:

$$v = c \sqrt{1 - \frac{{m}_{0}}{m}}$$

Where m₀ is the rest mass of the electron and m is about ½ the mass of the proton or neutron.

### Centripetal Force

To estimate the radii of the orbit of one of these two negatrons 10 orbiting positron 12 as shown in FIG. 1, we equate the electrostatic attractive force between the positron and the negatron which is:

$$F = \frac{{q}_{1} {q}_{2}}{4 {πϵ}_{0} {r}^{2}}$$

and the centripetal force of the very fast orbiting negatron which is:

$$F = \frac{{mv}^{2}}{r}$$

Thus we obtain a rough estimate of r as:

$$r = \frac{{q}^{2}}{4 {πϵ}_{0} {mv}^{2}}$$

Since m=½×1.67×10⁻²⁷ kg=0.835×¹⁰⁻²⁷ kg,

q=1.6×10⁻¹⁹C

v=0.9999994C, and

¼πe₀=9.0×10⁹ Nm²/c²:

r=3×10⁻¹⁸ m.

At this radii the Coulomb attractive forces between the orbiting negatron and the central positron is enormous:

$$F = \frac{{q}_{1} {q}_{2}}{4 {πϵ}_{0} {r}^{2}}$$

$$F = \frac{( 9.0 \times {10}^{9} {Nm}^{2} / {C}^{2} ) {( 1.6 \times {10}^{- 19} C )}^{2}}{{( 3 \times {10}^{- 18} m )}^{2}}$$

$$F = 2.5 \times {10}^{7} N$$

The centripetal force is the same:

$$F = \frac{{mv}^{2}}{r}$$

$$F = 2.5 \times {10}^{7} N$$

These calculations are very rough and only produce a general rough approximation of forces and distances. In the above calculations, I have neglected the effects of the second negatron 14 also orbiting the center positron. It has the same velocity as negatron 10 and the forces on negatron are the same as the forces on negatron 14. Negatrons 10 and 14, as they are attracted to positron 12 are repelled by each other with a force of about:

$$F = \frac{{q}_{1} {q}_{2}}{4 {πϵ}_{0} {r}_{2}^{2}}$$

where r₂ is effective separation of negatrons 10 and 14. A force calculation based of a separation between the two negatrons of about 6×10⁻¹⁸ m would produce a repelling force of about 0.64×10⁷ N. However, both are moving at almost the speed of light. Thus, the Coulomb force exerted by each negatron on each other should be somewhat greater than this since each negatron sees the other as being substantially closer than it really is. The faster the negatrons travel the closer the negatron on the opposite side of their orbit appears.

Thus, the two negatrons orbiting the center positron are repelled by each other with a force equal to at least 25 percent of the attractive force exerted by the positron on the two negatrons. It is this repelling force of the two negatrons acting on each other when added to the repelling centripetal force experienced by each that prevents either of them from spiraling into the positron and annihilating the positron and the first negatron to reach it. It may be that this repelling force creates force wells that established the stable orbits of the two negatrons so close but not too close to the central positron.

These three particles, the center positron 12 and fast orbiting negatrons 10 and 14 have a net charge of −1e and these three particles are orbited by two positrons 16 and 18 at a radius of about 0.5×10⁻¹⁵ m which establish the size of the proton. At this radius the Coulomb attractive force between each of the positrons and the three central electrons (with a net charge of −1.6×10⁻¹⁹C) is.

$$F = \frac{{q}_{1} {q}_{2}}{4 {πϵ}_{0} {r}^{2}}$$

$$F = \frac{( 9.0 \times {10}^{9} {Nm}^{2} / {C}^{2} ) {( 1.6 \times {10}^{- 19} C )}^{2}}{{( 0.5 \times {10}^{- 15} m )}^{2}}$$

$$F = 920 N$$

The positrons orbiting the center three-some must orbit fast enough so that their centripetal force approximately equals the Coulomb forces. Therefore, we can get a rough estimate of that velocity from:

$$F = \frac{{mv}^{2}}{r}$$

$$v = \sqrt{\frac{Fr}{m}}$$

If the velocity is much less than c, the mass of the positrons can be assumed to be equal to the positron rest mass, so:

v=2.2×10⁸ m/s

This is about 73 percent of the speed of light and as a result the mass would be increased about 50 percent above the rest mass of 9.1×10⁻³¹ kg or to about 13.6×10⁻³¹ kg which means that the velocity is somewhat less than the above estimate, maybe about ½ the speed of light. This model of the proton has the two positrons 16 and 18 orbiting on substantially the same path on opposite sides of the center three-some. As with the negatrons, the opposing positrons (along with the center positron) help prevent each other from spiraling into the lower orbiting electrons.

Therefore to summarize, the proposed model of the proton that I call the “Ross Proton Model” is shown in FIG. 1. It consists of a positron at a center position with two negatrons orbiting at a radius of about 3×10⁻¹⁸ m so fast that their combined mass is increased to a mass almost equal to the known proton mass. The two positrons orbiting at about 0.5×10⁻¹⁵ account for the rest of the mass of the proton that totals about 1.7×10⁻²⁷ kg. The orbit of the two positrons also establishes the measured size of the proton.

### Quarks

The reader may be wondering at this point how the Ross Proton Model squares with existing proton models. Accelerator experiments show that the proton can be broken apart. When this happens very short-lived particles are produced which decay into positrons and negatrons (plus photons and possibly neutrinos). The Ross Model is supported by this data. This experimental data also indicates (assuming the Ross Proton Model is correct) that the three central electrons are not stable by themselves. That is, they need the two orbiting positrons to help hold them in their very fast path around the central positron. Quarks are supposed to have charges such as +2e/3 and −1e/3. At page 633 of Modern Physics referred to above, the authors state: “Despite extensive experimental effort no isolated quark has ever been observed. Physicists now believe that quarks are permanently confined inside hydrons (i.e., protons and neutrons) because of an exceptionally strong force that prevents them from escaping. The Ross Proton Model does not need quarks to explain the construction of protons (or neutrons as explained below). Since no quark has ever been observed, I suspect that they don't exist.

### Neutrons

The Ross Neutron Model is merely a proton with an electron orbiting it. The measured mass of a neutron is greater than the combined mass of a proton and an electron by about 15×10⁻³¹ or about 160 percent of the mass of an electron. This difference can be accounted for by an increased mass associated with an electron velocity of about 0.78 c. This would imply an orbit close to the orbit of the outer two positrons in the Ross Proton Model. Alternately, the electron orbit might be farther out but its presence may cause the two electrons to orbit faster to produce the missing mass. The neutron is not stable, having a half-life of only about 15 minutes. The Ross Neutron Model is shown in FIG. 2. When neutrons are part of a nucleus their extra electron is probably shared more or less equally with the protons in the nucleus.

### Atomic Models

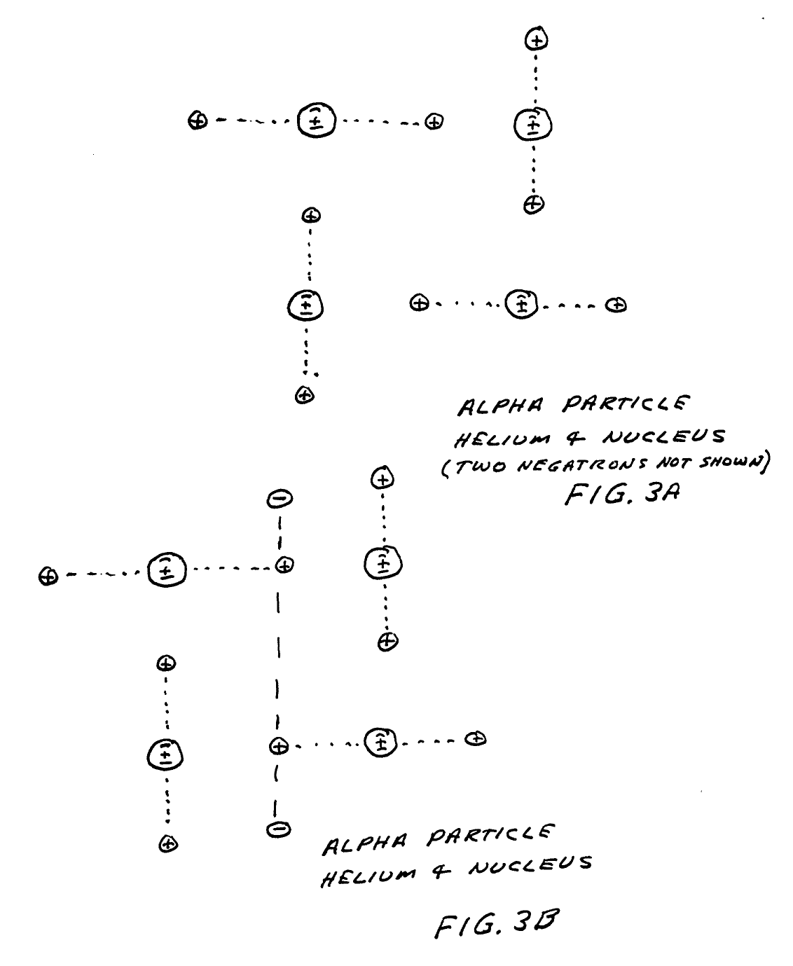

FIG. 3A shows a suggested arrangement of components of a helium 4 nucleus or an alpha particle according to the Ross Nuclear Model with the two extra negatrons (associated with the two neutrons of the helium nucleus) not shown. In this description, I will refer to the group of three positrons and two negatrons shown as shown in FIG. 1 as a “proton” recognizing that the group could have at least initially existed as a neutron with an extra electron orbiting as described above. This liberty is the result of my belief that a neutron (if it is ever identifiable as a separate entity in a nucleus can change places with a proton by having its outer negatron be stolen by a neighboring proton. The missing two negatrons in the FIG. 3A drawing are the outer negatrons of what the prior art refers to as the two neutrons in the nucleus of the helium atom or the alpha particle. Neutrons and protons each appear as five electrons, one positron at the center orbited closely at 3×10⁻¹⁸ m by two negatrons, with this threesome being orbited at 0.5×10⁻⁵ m by two positrons. The two extra negatrons are shown FIG. 3B in a close in more or less arbitrary orbit around a central position of the four “protons”. Many orbits of the two negatrons are possible. For example, the negatrons could orbit a single proton or they could orbit any combination of the four protons.

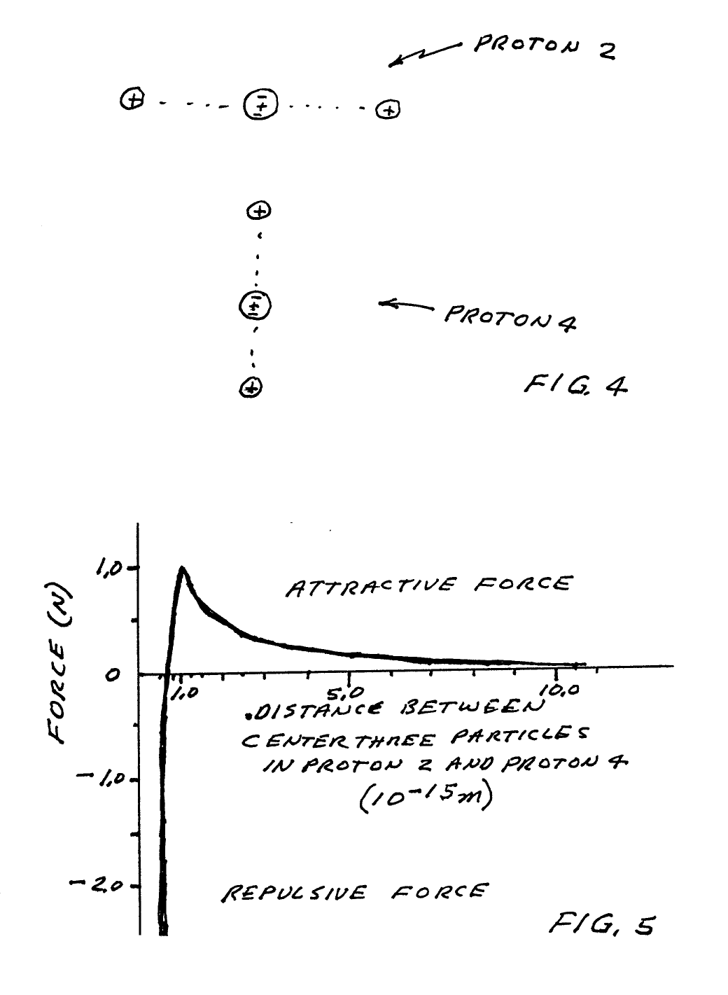

So now let us estimate the forces acting on the protons in this configuration. Remember, the prior art thinking has been that some mysterious God-like “strong force” (which no one could very well explain) must be acting to hold the positive charged protons together in the nucleus. To get a feel for the forces between these protons, let's just consider the forces between the two protons on the left side of the FIG. 3A diagram. These two protons are reproduced in FIG. 4. In FIG. 4 the central positrons and the close-in orbiting negatrons appear as small circles, each with a plus and two minus signs in it. On any scale showing the two inner orbiting negatrons (orbiting at 3×10⁻¹⁸ m) and the two orbiting positrons (orbiting at 0.5×10⁻¹⁵ m) the three inner particles would appear as a tiny spot with a charge of −e while the two orbiting positrons appear as two orbiting spots each with a charge of +e.

So now on with the Coulomb force calculation. (Remember from the Background section we reported that the prior art thinking was that the Coulomb force between two protons in a larger nucleus separated by 4×10⁻¹⁵ m was a repelling force of 14 N.) However, a close examination of FIG. 4 suggests that with the two protons arranged as shown, with the orbiting planes of the two orbiting positrons of each proton at right angles to each other, at certain distances the net forces of the particles making up the two protons could be attractive at certain ranges of separation and repelling at other ranges. For example at long separations (i.e., very long compared to the dimensions of the protons), the force acting between the protons is repelling since both have a net charge of +e. At very close separation, the closest positron of proton 4 will feel an attraction to the central three particles of proton 2 that is greater than the repulsion to the two orbiting positrons of proton 2. However, as the closest positron of proton 4 moves away from its position shown in FIG. 4, the repulsion from the orbiting positrons of proton 2 will exceed the attractive force of the central three particles of proton 2. Therefore, in the close position, the orbiting positrons of proton 4 will be both attracted and repelled as they make their orbits. The forces acting on the central three particles of proton 4 however would appear to be much more important in determining a stable position of proton 4 relative to proton 2 since their effective mass is about 1000 times greater than that of the orbiting positrons of proton 4. At long distances the central 3 particles of proton 4 feel a net attraction to proton 2, since the central 3 have a net negative charge and the net charge of proton 2 is positive. The closer proton 4 gets to proton 2 the stronger is the attraction of the central three particles of proton 4 to proton 2. However, once the central three particles of proton 4 approach very close to the central three particles of proton 2, the repulsive force due to the central three particles of proton 2 overcome the attractive force of the two orbiting positrons of proton 2 and the force from proton 2 acting on the central three particles of proton 4 becomes repulsive. Therefore, a “force well” is created between the particles of proton 2 and the central 3 particles of proton 4. Once the central three particles of proton 4 are in this well they cannot easily escape. I estimate for example that at a separation of about 0.5×10⁻¹⁵ m between the three central particles of the two protons, the central three particles of proton 4 are very strongly repelled from proton 2, but from about 0.7×10⁻¹⁵ m to about 5×10⁻¹⁵, the central three particles of proton 4 are very strongly attracted to proton 2, with the strongest attraction at a separation of about 1×10⁻¹⁵ m. The orbiting positrons of proton 4 do not like being so close to the orbiting positrons of proton 2, but they are very light as compared to the central three particles so they are not very determinative of the position of proton 4. Their orbits will be substantially altered from circular as a consequence of the pushing and pulling from the particles of proton 2 as the positrons of proton 4 make their many very quick journeys around the central three particles of proton 4. FIG. 5 is a graph of my very rough estimate of the forces acting between the particles of proton 2 and the central three particles of proton 4.

### Calculation Example

The following is a calculation to estimate the attractive force acting between the central three particles of proton 4 and the particles of proton 2 when the central three particles of proton 4 are located 1×10⁻¹⁵ m from the orbit plane of proton 2. The net force is difference between: (i) the attractive force between central three particles of proton 4 and the two orbiting positrons of proton 2 and (ii) the repulsive force between the central three particles of proton 2 and the central three particles of proton 4.

### Force Exerted by the Particles of Proton 2 on Central Three Particles of Proton 4

When the central three particles of protons 2 and 4 are separated by 1.0×10⁻¹⁵ m, the central three particles of proton 4 are separated from the proton 2 orbiting positrons by about 1.12×10⁻¹⁵ m and each of these positrons attract the three central particles of proton 4 at an angle of 26.5 degrees with the orbit axis of the positrons. (These estimates are based on the assumption that the orbits of the proton 2 orbiting positrons are not changed very much due to the presence of proton 4.) The cosine of 26.5 degrees is 0.894. Thus, the attractive force from proton 2 (due to the pull of the orbiting positrons) on the central three particles of proton 4 in a direction toward the central three particle of proton 2 is:

$$F = \frac{2 {q}^{2} ( 0.894 )}{4 {πϵ}_{0} {r}^{2}} = \frac{( 2 ) ( 9.0 \times {10}^{9} {Nm}^{2} / {C}^{2} ) {( 1.6 \times {10}^{- 19} C )}^{2} ( 0.894 )}{{( 1.2 \times {10}^{- 15} m )}^{2}} = 326.9 N$$

The repulsive force (due to the repulsive force between the center three particles of the two protons) is:

$$F = \frac{{q}^{2}}{4 {πϵ}_{0} {r}^{2}} = \frac{( 9.0 \times {10}^{9} {Nm}^{2} / C ) {( 1.6 \times {10}^{- 19} C )}^{2}}{{( 1.0 \times {10}^{- 15} m )}^{2}} = 230.4 N$$

The net force is:

F=+326.9−230.4=+96.5 N

which is a very strong attractive force.

As indicated above and shown on FIG. 5 if proton 4 approaches proton in the direction shown in FIG. 4, the center three particles of proton 4 will be strongly attracted to proton 2 until the center three particles are within about 1×10⁻¹⁵ m of proton 2 at which time the attraction drops sharply and at about 0.6×10⁻¹⁵ m the center three particles are repulsed. The center three particles of proton 4 will quickly find its zero force location somewhere around 0.6×10⁻¹⁵ m from the center of proton 2 and will probably oscillate about that zero force position at a very large frequency. As the particle of the two protons approach each other, the orbiting positrons of proton 4 are strongly affected by the positive and negative particles of proton 2 and their orbits will fluctuate wildly until they find an equilibrium orbit.

The other protons of the helium nucleus will arrange themselves in a similar configuration, a possible configuration being the one shown in FIGS. 3A and B. The atoms heavier than helium will have its protons arranged in a manner similar to that shown for helium. It should be relatively easy for persons skilled in this art to construct computer models which would model the Coulomb forces of these particles and would predict the shape of these nuclei including the helium nuclei much more accurately than I have done here with my very simple calculations. These calculation are not intended to be precise. Persons skilled in the art of nuclear physics will be able to greatly improve on my extremely rough calculations. The purpose of these calculations is merely to show that there are potential configurations of positrons and negatrons which can account for the mass, size and charge of protons and neutrons, and that there are configurations of protons and neutrons based on this model that can explain the structure of atomic nuclei.

### Implications of the Ross Nuclear Model

The structure of protons, neutrons, nuclei, atoms, the earth, us and the rest of the universe can be explained very simply without resort to the strong force, quarks and other prior art theories of “modern physics” that the leading writers apparently believe in without proof of their existence. This model also, better than any other example that I am aware of, shows that mass and energy really are the same thing! Positrons and negatrons are generated from a high-energy photon that has energy, a velocity of c but no mass. We also know that when a positron and a negatron collide both may be annihilated with the production of two high-energy gamma rays. Thus, positrons and negatrons are merely packages of stored electromagnetic energy. Protons and neutrons are, in the Ross models, nothing but combinations of these packages of energy. Two of the negatrons are moving extremely fast, fast enough to produce almost all of what we have thought of as the mass of these particles. So we can easily say now that protons and neutrons are nothing but energy. Atoms are made of protons and neutrons along with some orbiting negatrons (also energy) and the masses of all of the things in the universe is made of atoms or parts of atoms. Therefore, we could say, if my model is correct, that the universe is made of only energy. We have known for many years that mass and energy are equivalent. With this model, mass is energy!

This model also is consistent with the notion that for each negatron, there must be a positron. In my model the universe has exactly the same number of negatron as positrons. With this model, believers will have a good time revising theories dealing with the big bang. It is very easy to understand how the energy released in the big bang would have created billions and billions and billions of equal numbers of positrons and negatrons each which quickly would have quickly annihilated one of its opposites or would have combined with four other electrons to form a proton or five other electrons to form a neutron. The protons are extremely stable. Most of them would have soon captured a negatron to form a hydrogen atom. The neutrons would either have combined with a proton or would have quickly decayed to a proton.

Believers also will find it easy to explain the origin of the last big bang and to predict the next big bang. Since we now understand the basic structure of nuclei, we can understand what will happen when all the matter of the universe comes crushing in to almost a single point. This is possible if positrons and negatrons are single points, since there are equal numbers of them and since positrons and negatrons love each other as much as they hate their own kind. Think of the fun we will have calculating the energy released when all of these positrons and negatrons of all the atoms of the known universe are crushed together and annihilate each other.

Eliminating the strong force from the vocabulary of nuclear physicists may cause some to question the gravitation force. I suspect that on close analysis, we will find that the force of gravity is merely another manifestation of the Coulomb force. Under the Ross models we have now a world of energy. Mass is energy, all based on Coulomb forces. I have not figured out how, but I believe that we will find that gravity is the result of Coulomb attraction. The attractive force of atomic nuclei acting on far away orbiting electrons may be more effective than the repulsive force of electrons and nuclei acting on their respective counterparts. This difference in Coulomb effects may be enough to account for the relatively very weak force of gravity.

On a more practical side, believers (if there are any) will want to do some experiments to see if they can make a proton according to the recipe suggested in this specification. This would be to toss into a target space a positron at rest or moving slowly. Then direct two negatrons toward it in almost exactly opposite directions to arrive at the positron at the same time. These negatrons should be traveling at almost the speed of light. Two positrons should also be fired toward the positron from opposite directions and at right angles to the paths of the two negatrons. The two positrons should be traveling at about one half the speed of light and should arrive in the vicinity of the stationary or slow moving positron at the same time as each other and very, very soon after the arrival of the negatrons.

If the Ross Proton Model is correct, it should be apparent that the proton (the hydrogen nucleus) has within it one heck of a lot of energy orbiting around. Therefore, we may want to put some effort into trying to figure out how to release that energy. The energy available is many orders of magnitude greater (for a given amount of hydrogen) than that released in a hydrogen bomb. The current belief is the in a hydrogen bomb two hydrogen nuclei are converted to a helium nucleus. The energy released is the difference in mass of the two hydrogen nuclei and the mass of the helium nucleus. This is a small fraction of the mass of a hydrogen nucleus. If this model is correct all (or almost all) of the mass of the hydrogen nucleus would be released if we could cause it to break apart. If we could knock off one of the orbiting positrons, the remaining particle would probable be unstable and decay rapidly into positron and negatrons flying apart at high speeds or annihilating each other along with the release of gamma rays.

### Correctness of Model Doubted

The model of the proton and the model of atomic nuclei presented above constitute a major departure from the most widely accepted theories explaining the makeup of nuclear particles. If the Ross models are anywhere close to being correct all physics books written during the past 20 years will have to be substantially revised. The Applicant recognizes that the models presented above are probable not correct. Applicant recognizes that many of the smartest people in the world have devoted their lives to efforts directed at explaining the makeup of these nuclear particles. If the above models are correct, Applicant finds it very difficult to believe that at least one of those brilliant people would not have developed them long ago. Nevertheless, Applicant has described his models in the very long shot belief that they might be correct or that they are close to correct. He has not had his math checked by any of his very smart friends so he recognizes that the models may be full of stupid embarrassing mistakes. Applicant has presented his nuclear model as a patent application for two reasons: (1) he is a patent attorney (a long time ago he used to be a nuclear engineer) and is familiar with patent applications as a technique for publishing discoveries and (2) a patent application is at least initially kept secret and can be abandoned, so if he learns soon that he has made foolish mistakes, he can perhaps minimize his embarrassment.

### Processes for Testing and Evaluating

### Ross Proton Model and Ross Nuclear Model

Many process for testing and evaluating the Ross Proton Model, the Ross Neutron Model and the Ross Nuclear Model are available. One process is for a person experienced in modern nuclear physics to evaluate the models as they have been presented in this specification. This can easily be accomplished with a hand calculator.

### Computer Models

A more sophisticated evaluation would be to utilize a digital computer model incorporating one or more of the Ross models. It should be fairly simple to model the positrons and negatrons in the Ross Proton Model and determine if the model is stable. If I am right, the Ross proton should be enormously stable. By making the computer model a little more complicated, it should be feasible to determine how hard it would be to make a proton using the technique described above for doing that. Perhaps then the computer model could be extended to predict the formation of protons in the Ross model during the process that followed the big bang. Once the Ross proton and the Ross neutron have been modeled on a digital computer it would be relatively simple to create similar computer models to examine the Ross Nuclear Model. After these models are created investigations could be preformed to determine if a technique can be developed to breakup the proton and release its energy. If this could be done economically, we would have what may be the most important invention since the beginning of civilization.

### Nuclear Tests and Experiments

If computer modeling shows that the Ross models are correct or that modifications or derivations of the Ross models are correct. A next step is to perform some experiments with particle accelerators to test the models or aspects of the models. It may be that current accelerators do not have the capabilities to properly investigate the Ross models. If so and if the models are shown to be possibly correct then perhaps accelerators can be built to properly test the models.

While preferred embodiments of the present invention are described above, the reader should not construe the present invention as limited by the above description. In fact persons skilled in nuclear physics will envision many other possible variations within the scope of the present invention. For example, other models of proton, somewhat more complicated than the one described above may be the true proton model. For example, instead of two negatrons in the close-in orbit there could be four or six with a corresponding four or six positrons in the outer orbit, again to give the proton a plus 1 charge. The basic Ross Proton Model is a proton that is comprised of only electrons, the electrons including a plurality of positrons and a plurality of negatrons, with at least one of said electrons orbiting at least one other of said electrons at a velocity great enough to increase the mass of electrons to equal a proton mass of about 1.67×10⁻²⁷ kg. If the models described above of the proton, the neutron and nuclei prove to be correct, I expect that virtually all phases of nuclear physics will have to be modified to incorporate the present invention. In addition, processes involving many other branches of physics will need to be revised for a correct understanding of the true nature of the atomic structure. The above disclosures may also be useful in processes for analyzing electromagnetic radiation, especially high-energy radiation. Accordingly, the reader is requested to determine the scope of the invention by the appended claims and their legal equivalents and not by the above examples.

I claim:

1) A process for analyzing subatomic particles comprising the steps of:
A) creating a model of a proton comprised of electrons, said electrons including a plurality of positrons and a plurality of negatrons, with at least one of said electrons orbiting at least one other of said electrons at a velocity great enough to increase the mass of said at least one of said electrons so that the mass of all of said electrons equal or approximately a proton mass of about 1.67×10⁻²⁷ kg,
B) programming a digital computer to perform analyses using said proton model.

2) A process as in claim 1 wherein said electrons include:
A) a first positron,
B) two negatrons orbiting said first positron each at a velocity, defining a negatron velocity, very near the speed of light, said first positron and said two orbiting negatrons defining a center three-some, and
C) two positrons orbiting said center three-some.

3) A process as in claim 2 wherein said negatron velocity is about 0.9999994 c, where c is the speed of light.

4) A process as in claim 1 and further including the step of creating a model of a neutron said model of the neutron comprising all of the electrons of the proton and an additional negatron.

5) A process as in claim 4 wherein said additional negatron is in orbit at a velocity large enough to increase its mass by at least 50 percent.

6) A process as in claim 1 and further comprising the steps of creating model of at least one atomic nucleus comprised of a plurality of protons, each of said plurality of protons being comprised of a plurality of positrons and negatrons.

7) A process as in claim 6 and further comprising the step of programming said digital computer to analyze forces acting in said atomic nucleus.

8) A process as in claim 7 wherein said forces are only Coulomb forces.

9) A process as in claim 1 wherein said process further includes a step of using said digital computer to analyze a hydrogen fusion reaction.

10) A process as in claim 9 wherein said fusion reaction is assumed to occur in a thermonuclear explosion.

11) A process as in claim 9 wherein said fusion reaction is assumed to occur in a controlled thermonuclear reaction.

12) A process as in claim 7 wherein said process further includes a step of using said digital computer to analyze a hydrogen fusion reaction.

13) A process as in claim 12 wherein said fusion reaction is assumed to occur in a thermonuclear explosion.

14) A process as in claim 12 wherein said fusion reaction is assumed to occur in a controlled thermonuclear reaction.

15) A process as in claim 1 wherein said digital computer is programmed to analyze the big bang.

16) A process for making a proton comprising the steps of:
A) positioning a positron in a target region of a particle accelerator,
B) directing two negatrons at said target region each at a velocity very close to the speed of light, and
C) directing two positrons at said target region.

17) A process as in claim 16 wherein said two negatrons are directed in directions opposite each other and said two positrons are directed in directions opposite each other.
